(19) United States
(12) Patent Application Publication
(10) Pub. No.: US 2012/0009938 A1
(43) Pub. Date: Jan. 12, 2012

(54) CELLULAR LOCATION SYSTEM AND CELLULAR LOCATION METHOD

(76) Inventors: Jun LIU, San Marcos, CA (US); Thomas Williston Head, Chantilly, VA (US); Osama Hussein, Leesburg, VA (US)

(21) Appl. No.: 12/833,263

(22) Filed: Jul. 9, 2010

(51) Int. Cl. H04W 24/00

(52) U.S. Cl. 455/456.1

(57) ABSTRACT

A cellular location method uses a cellular location system including a database. The cellular location method obtains radio measurements from a user terminal located in the communications network, extracts information from the obtained radio measurements, determines the location of the user terminal based on the extracted information, and stores the determined location of the user terminal and the extracted information as an entry in the database. Additionally, the cellular location method estimates information for the user terminal for another location in the communications network. The estimated information for the user terminal may be based upon the extracted information for the user terminal or upon obtained information from a co-sited communications network. A location of the specified user terminal can be obtained based on a matching score between measurements from the specified user terminal and the stored user terminal measurements including the extracted information and the estimated information.

### BACKGROUND OF THE INVENTION

1. Field of the Invention

The present invention relates to a cellular location system and a cellular location method in a communications network, and more particularly, to a cellular location system and a cellular location method in which the location of a user terminal is determined via database correlation.

2. Description of the Related Art

Techniques for determining the location of a user terminal in a cellular network can generally be classified into the following three categories.

The first category for determining the location of a user terminal in a cellular network is that the location of the user terminal may be determined by way of a Global Positioning System (“GPS”) or an Assisted Global Positioning System (“AGPS”). However, in order for GPS or AGPS to be used, it is required that the user terminal include a GPS or an AGPS receiver. Accordingly, GPS or AGPS is not always available to be used to determine the location of a user terminal since some user terminals may not be equipped with a GPS or an AGPS receiver. Additionally, this technique suffers from the drawback that position related measurements are not available unless the user terminal or the other cellular network equipment initiates a location request.

The second category for determining the location of a user terminal in a cellular network involves obtaining Time Of Arrival (“TOA”) or Time Difference Of Arrival (“TDOA”) measurements from the user terminal or other cellular network equipment. As with GPS or AGPS, a location system based on TOA or TDOA is not always available to be used as the user terminal or the other cellular network equipment must be configured to obtain TOA or TDOA measurements. Additionally, as with GPS or AGPS, location determination by TOA or TDOA suffers from the drawback that position related measurements are not available unless the user terminal or the other cellular network equipment initiates a location request.

The third category for determining the location of a user terminal in a cellular network involves database correlation between stored user terminal measurements and obtained user terminal measurements to determine a location of the user terminal. In database correlation, a database is built from previously obtained radio measurements and/or predicted radio values.

After a database is sufficiently built up, a location of a user terminal can be readily determined by a mobile or base station using radio measurements obtained from the user terminal. In such a system, the obtained measurements are compared to entries within the database, and a best matching database entry (which includes an estimated location for the user terminal) is found using a predetermined method.

In a conventional cellular location system employing database correlation, prior radio measurements are typically obtained by technicians traveling to various spots within the cellular network, and using specialized equipment to obtain on-site radio measurements. However, if the cellular network area is large, using the above method to obtain data for the database can be very expensive and time-consuming.

In order to solve the above problem, other conventional cellular location systems employing database correlation obtain fewer on-site radio measurements, and subsequently, use prediction tools (e.g., propagation models of the cellular network) to obtain predicted values for locations where on-site radio measurements were not obtained. While this alternative conventional method reduces the cost needed to build up a database, the predicted values are subject to significant calibration in order to obtain accurate values.

In view of the above deficiencies in the prior art, there exists a need for an efficient and effective cellular location system and cellular location method employing database correlation.

### SUMMARY OF THE INVENTION

An embodiment of the present invention relates to a cellular location method for determining the location of a specified user terminal in a communications network in which a database containing user terminal measurements and corresponding locations is built up over time and location. In particular, the cellular location method obtains radio measurements from a user terminal located in the communications network, extracts information from the obtained radio measurements, determines the location of the user terminal based on the extracted information, and stores the determined location of the user terminal and the extracted information as an entry in the database. Additionally, the cellular location method estimates information for the user terminal for another location in the communications network. The estimated information for the user terminal may be based upon the extracted information for the user terminal or upon obtained information from a co-sited communications network. A location of the specified user terminal can be obtained via the database based on a matching score between measurements from the specified user terminal and the stored user terminal measurements including the extracted information and the estimated information.

An embodiment of the present invention includes a cellular location system for determining the location of a specified user terminal in a communications network in which a database containing user terminal measurements and corresponding locations is built up over time and location. In particular, the cellular location system includes an obtaining unit for obtaining radio measurements from a user terminal located in the communications network, an extracting unit for extracting information from the obtained radio measurements, a determining unit for determining the location of the user terminal based on the extracted information, and a database for storing the determined location of the user terminal and the extracted information as an entry in a database. Additionally, the cellular location system included an estimation unit for estimating information for the user terminal for another location in the communications network. The estimated information for the user terminal may be based upon the extracted information for the user terminal or upon obtained information from a co-sited communications network. A location of the specified user terminal can be obtained via the database based on a matching score between measurements from the specified user terminal and the stored user terminal measurements including the extracted information and the estimated information.

An embodiment of the present invention relates to a non-transitory computer readable recording medium having recorded thereon a cellular location program that when executed causes a computer to perform a cellular location method for determining the location of a specified user terminal in a communications network in which a database containing user terminal measurements and corresponding locations is built up over time and location. In particular, the cellular location method obtains radio measurements from a user terminal located in the communications network, extracts information from the obtained radio measurements, determines the location of the user terminal based on the extracted information, and stores the determined location of the user terminal and the extracted information as an entry in the database. Additionally, the cellular location method estimates information for the user terminal for another location in the communications network. The estimated information for the user terminal may be based upon the extracted information for the user terminal or upon obtained information from a co-sited communications network. A location of the specified user terminal can be obtained via the database based on a matching score between measurements from the specified user terminal and the stored user terminal measurements including the extracted information and the estimated information.

### BRIEF DESCRIPTION OF THE DRAWINGS

FIG. 1 illustrates an exemplary implementation of a cellular network including a cellular location system in accordance with an embodiment of the present invention.

FIG. 2 illustrates a flowchart for building up a database within a cellular location system in accordance with an embodiment of the present invention.

FIG. 3 illustrates a flowchart for calibrating and building up a database within a cellular location system in accordance with an embodiment of the present invention.

FIG. 4 illustrates a flowchart for building up a database within a cellular location system in accordance with an embodiment of the present invention.

FIG. 5 illustrates a flowchart for determining a location of a user terminal in accordance with an embodiment of the present invention.

FIG. 6 illustrates a representative cellular location system as shown in the cellular network of FIG. 1 in accordance with an embodiment of the present invention.

### DETAILED DESCRIPTION OF THE INVENTION

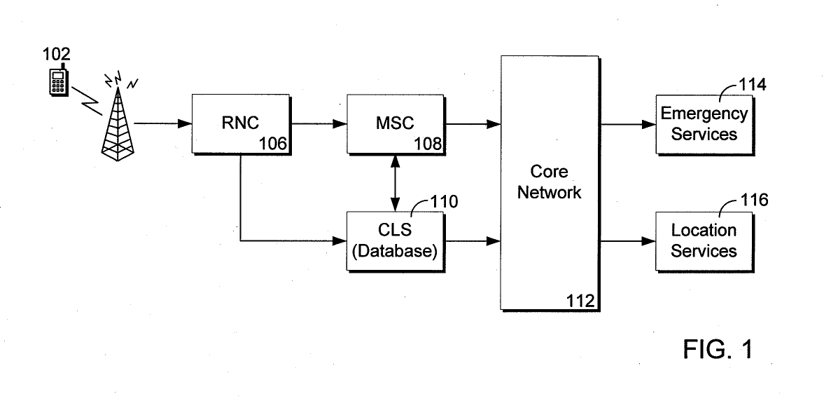

FIG. 1 illustrates an exemplary implementation of a cellular network including a cellular location system in accordance with an embodiment of the present invention. It should be noted that the present invention is not limited to the embodiment illustrated in FIG. 1, and that one of ordinary skill in the art would find it apparent that the present invention may be differently implemented.

In FIG. 1, the cellular location system 110 (“CLS”) interfaces with a user terminal 102 via a radio network controller 106 (“RNC”) in order to obtain radio measurements from the user terminal 102. The radio measurements obtained by the RNC 106 are then compared to entries stored in the database within the CLS 110 to determine a location of the user terminal 102. Additionally, the CLS 110 can interface directly with the core network 112 to transmit the determined location information of the user terminal 102 to location services 116, or in conjunction with a mobile switching center (“MSC”) 108, transmit the determined location information of the user terminal 102 to emergency services 114.

The CLS 110 will be further described below with reference to a Global System for Mobile Communications (“GSM”) network in accordance with an embodiment of the present invention. However, it should be noted that the present invention is not limited to such an embodiment, and it should be apparent to one of ordinary skill in the art that the present invention can be easily modified so as to be employed in different telecommunication systems.

In a GSM network, a user terminal (hereafter “UT”) continuously performs measurements for determining a received power level (“Rx_Lev”) for a serving sector and any neighboring sectors, and performs measurements for determining a received signal quality (“Rx_Qual”) for the serving sector. When the Rx_Lev it too low for the serving sector, or the Rx_Qual is too low for the serving sector, a handover event occurs in which the UT will handover to the neighboring sector having the greatest Rx_Lev. It should be noted that a GSM networks implements a “hard” handover scheme, in which the UT only has one radio link at a time. As a result, only time information (such as a timing advance value) corresponding to the serving sector is available. Additionally, timing advance values are measured by a base transceiver station (“BTS”) rather than the UT in a GSM network, and the timing advance values correspond to the length of time that a signal from the UT takes to reach the BTS.

As noted above, the UT in a GSM network measures the Rx_Lev values for the serving sector and any neighboring sectors. However, it should be noted that only the values for the serving sector and six of the neighbor sectors with the largest Rx_Lev values are reported. The UT in a GSM network reports the measurements approximately every half second. In this regard, the UT reports the following measurements every half second: Rx_Lev and Rx_Qual for the serving sector; and Rx_Lev for six neighboring sectors having the largest Rx_Lev values.

For the purpose of this disclosure, the cellular network is an exemplary cellular network in which a network area is partitioned into small regions, with the center of each region being referred to as a “pixel.” Accordingly, a pixel location (xᵢ, yᵢ) represents one region within the cellular network area.

The above partitioning of the cellular network area allows the database within the CLS 110 to be constructed as a look-up table containing any location sensitive parameters available at each pixel location. As an example, Table 1 is illustrated below in which power values (marked by “l”) and a corresponding estimated location is stored as a look-up entry in the database within the CLS 110.

TABLE 1
Example structure of the look-up table

| Location Pixel | Cell 1 | Cell 2 | Cell 3 | . . . | Cell n |
|---|---|---|---|---|---|
| (x₁, y₂) | (l_{1,1}) | (l_{2,1}) | (l_{3,1}) | . . . | (l_{n,1}) |
| (x₂, y₂) | (l_{1,2}) | (l_{2,2}) | (l_{3,2}) | . . . | (l_{n,2}) |
| . . . | . . . | . . . | . . . | . . . | . . . |
| (xᵢ, yᵢ) | (l_{1,i}) | (l_{2,i}) | (l_{3,i}) | . . . | (l_{n,i}) |
| . . . | . . . | . . . | . . . | . . . | . . . |

With reference to Table 1, let n be the number of measured cells within the cellular network, and let E(xᵢ, yᵢ) be a look-up entry at the pixel location (xᵢ, yᵢ) and be illustrated by equation (1.1) below.

E(xᵢ,yᵢ)=[(l_{1,i}),(l_{2,i}),(l_{3,i}), . . . ,(l_{n,i})], Equation (1.1):

where l_{1,i}, l_{2,i}, . . . , l_{n,i} are power values (such as Rx_Lev) on n measured cells at the pixel location (xᵢ, yᵢ).

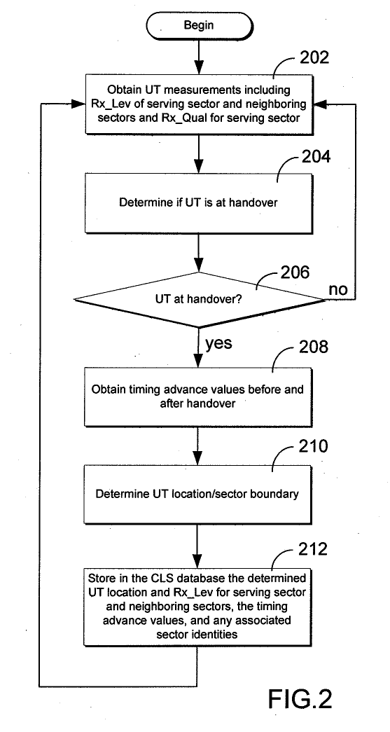

FIG. 2 illustrates a flowchart for building up a database within the CLS 110 in accordance with an embodiment of the present invention. After initialization, at Step 202, the CLS 110 obtains UT internal measurements including Rx_Lev for the serving sector and any neighboring sectors, and Rx_Qual for the serving sector.

At Step 204, the CLS 110 determines whether the UT is at a point in which a handover event is necessary based on the obtained UT internal measurements.

At Step 206, if the CLS 110 determines that a handover event is not necessary for the UT, the process is repeated from Step 202. If it is determined that a handover event is necessary for the UT, the CLS 110, at Step 208, temporarily stores in a memory the obtained UT internal measurements, and obtains timing advance values before and after the handover event from a BTS.

At Step 210, the CLS 110 determines the location of the UT based on the obtained timing advance values before and after the handover event. The determination of the location of the UT based on the obtained timing advance is beyond the scope of the present disclosure, and therefore, a detailed description of such is not provided. Additionally, because a GSM network operates via “hard” handover, the determined UT location also serves as a sector boundary between the previous serving sector and the current serving sector. Further, it is noted that the accuracy of the estimated location of the UT based on the obtained timing advance values can be improved when other measurements are available. For example, the accuracy of the estimated location of the UT would be improved if angle of arrival (AOA) measurements are obtained.

At Step 212, an entry is created in the database within the CLS 110 in which the obtained values of Rx_Lev for the serving sector and neighboring sectors, the obtained timing advance values, and any associated cell identities, along with the corresponding determined UT location are stored. The process is then repeated in order to build up the database within the CLS 110 over time and location. Additionally, it should be noted that there exist alternative methods for using the determined locations of user terminals in the database. As an example, for all determined locations of user terminals that fall into a region, their estimated location vectors may be averaged as one common vector, and the estimated location is represented by the pixel location (xᵢ, yᵢ) representing the region.

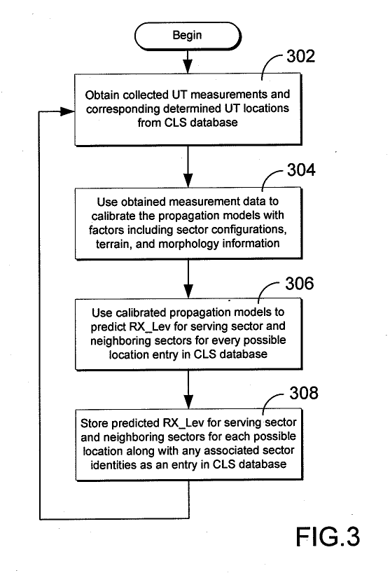

FIG. 3 illustrates a flowchart for calibrating a database within a cellular location system in accordance with an embodiment of the present invention.

At Step 302, UT measurements and corresponding UT locations are obtained from the database within the CLS 110. As described above with reference to FIG. 2, the UT measurements may include, but are not limited to, collected Rx_Lev values corresponding to a determined UT location.

At Step 304, the obtained UT measurements are used by the CLS 110 to calibrate propagation models. The result of the calibration should take into account factors such as sector configurations, terrain, and morphology information by determining appropriate path loss parameters or the like.

As an example of performing calibration of the propagation models, it is shown below how to use obtained Rx_Lev values at known UT locations within the communications network for calibrating a path loss model. In particular, path loss parameters a and b are determined based on the obtained Rx_Lev values.

The COST231 Hata Model for propagation loss is described by equation (1.2) below.

l(d)=a*log 10(d)+b, Equation (1.2):

where l(d) is an obtained power measurement, d is a distance between a base station and the UT, and a and b are the path loss parameters to be determined.

If d′ is substituted for log 10(d) such that d′=log 10(d), equation (1.2) is reduced to equation (1.3) below.

l(d′)=a*d′+b. Equation (1.3):

Equation (1.3) may be applied for K collected measurements l(d′ₖ), k=1, 2, . . . ,K, yielding equation (1.4) below.

l(d′ₖ)=a*d′ₖ+b+σₖ, Equation (1.4):

where σₖ is the difference between the collected measurement and a predicted measurement.

Accordingly, the least squares estimate of the path loss parameters can be described by equation (1.5) below.

$$[ \begin{matrix}\hat{a} \\ \hat{b}\end{matrix} ] = {( {D}^{T} D )}^{- 1} {D}^{T} L , \\ where D = [ \begin{matrix}{d}_{1}^{′} & 1 \\ {d}_{2}^{′} & 1 \\ … & … \\ {d}_{K}^{′} & 1\end{matrix} ] , and L = [ \begin{matrix}l ( {d}_{1}^{′} ) \\ l ( {d}_{2}^{′} ) \\ … \\ l ( {d}_{K}^{′} )\end{matrix} ] . \qquad Equation ( 1.5 )$$

At Step 306, the calibrated propagation models are used to predict Rx_Lev values for a serving sector and neighboring sectors for every possible location entry in the database within the CLS 110.

As an example, it is noted that the received power at the UT from a Base Station (“BS”) is described by equation (1.6) below.

EIRP_{BS}+G_{BS}−Lₚₐₜₕ+G_{MS}−L_{MS}, Equation (1.6):

where EIRP_{BS} is the Equivalent Isotropically Radiated Power (“EIRP”) of the base station, G_{BS} is the antenna gain of the base station, including attenuation due to antenna pattern, Lₚₐₜₕ is path loss from the base station antenna to the UT antenna, G_{MS} is the antenna gain of the mobile, and L_{MS} is the terminal loss of the mobile.

By combining Equations (1.2) and (1.5), the calibrated propagation model at a location (x, y) can be described by Equation (1.7) below.

\hat{l}(d_{x,y})=\hat{a}*log 10(d_{x,y})+\hat{b}, Equation (1.7):

where d_{x,y} is the distance from the BS to the location (x, y).

Accordingly, the predicted Rx_Lev value from the BS received by the UT at the location (x, y) can be determined by Equation (1.8) below.

Rx_{—}Lev(x,y)=EIRP_{BS}+G_{BS}−\hat{l}(d_{x,y})+G_{MS}−L_{MS}. Equation (1.8):

At Step 308, entries are created in the database within the CLS 110 in which the predicted values of Rx_Lev for the serving sector and any neighboring sectors, along with their corresponding UT locations are stored. Additionally, if any associated sector identities are available, this information is also stored in correspondence with their UT locations. The above-described process is then repeated in order to calibrate and build up the database within the CLS 110 over time and location.

It should be noted that the above-described method is not limited in application to a GSM network, and it would be apparent to one of ordinary skill in the art that the above-described method can easily be applied to different telecommunications networks. For example, the above-described method may be applied to a LTE network in which UT measurements include Evolved Universal Terrestrial Radio Access (“E-UTRA”) Reference Signal Received Power (“RSRP”) values. It should be noted that E-UTRA RSRP values are similar to Rx_Lev values in GSM.

Additionally, when another telecommunications network is deployed at the same site as a GSM network, power and time measurements collected by the co-sited network are useful to build up the database within the CLS 110. For example, if a Universal Mobile Telecommunications System (“UMTS”) network is co-sited with a GSM network, power and time measurements (such as downlink path loss and propagation delay) collected by the UMTS network are useful to calibrate the propagation models or to predict values for the GSM network such that the database within the CLS 110 may be built up. It should be noted that building up of the database in the manner is not limited to when a GSM network is co-sited with a UTMS network, and that it should apparent to one of ordinary skill in the art that power and/or time measurements from other telecommunications networks may be used (e.g., a CDMA network).

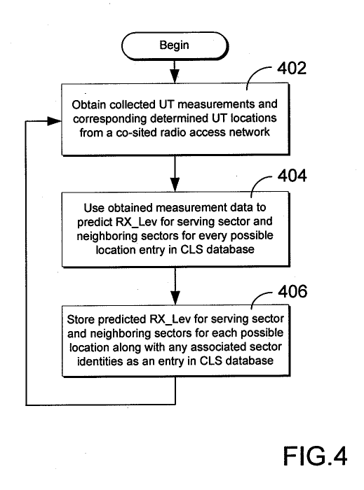

FIG. 4 illustrates a flowchart for building up a database within a cellular location system in accordance with an embodiment of the present invention when a UMTS network is co-sited with a GSM network, in which the GSM network and the UMTS network share the same antenna and the same frequency spectrum. In such a scenario, downlink path loss measurements collected from the overload UMTS network can be used directly as power measurements in the GSM network. It is noted that the collecting and archiving of radio measurements in the UMTS network is beyond the scope of the present disclosure, but may be determined by, but not limited to, the method disclosed in co-pending application U.S. patent application Ser. No. 12/818,440, the disclosure of which is herein incorporated by reference.

At Step 402, collected UT measurements and their corresponding determined UT locations are obtained from a co-sited radio access network.

At Step 404, the obtained measurement data is used to predict Rx_Lev for the serving sector and any neighboring sectors for every possible location entry in the database within the CLS 110.

As discussed in co-pending patent application Ser. No. 12/818,440, power measurements made by a UT at known locations in a UMTS network may be collected and stored within a database. In a UMTS network, the Common Pilot Channel (“CPICH”) Received Signal Code Power (“RSCP”) measurements (i.e., power measurements) made by a UT at a known location (x, y) are described by equation (1.9) below.

RSCP(x,y)=EIRP_{BS}^{UMTS}+G_{BS}^{UMTS}−Lₚₐₜₕ^{UMTS}+G_{MS}^{UMTS}−L_{MS}^{UMTS}. Equation (1.9):

When a UMTS network is co-sited with a GSM network, in which the GSM network and the UMTS network share the same antenna and the same frequency spectrum, the antenna gain of the base station and the path loss from the base station to the UT are the same for both UMTS and GSM (i.e., G_{BS}^{UMTS}=G_{BS}^{GSM} and Lₚₐₜₕ^{UMTS}=Lₚₐₜₕ^{GSM}). Consequently, the Rx_Lev value for a UT in the GSM network at the known location (x, y) can be determined as described in equation (1.10) below.

$$Rx\_Lev ( x , y ) = RSCP ( x , y ) + ( {EIRP}_{BS}^{GSM} - {EIRP}_{BS}^{UMTS} ) + ( {G}_{MS}^{GSM} - {G}_{MS}^{UMTS} ) - ( {L}_{MS}^{GSM} - {L}_{MS}^{UMTS} ) . \qquad Equation ( 1.10 )$$

Additionally, it should be noted that the above-described method is not limited in application to a GSM network, and it would be apparent to one of ordinary skill in the art that the above-described method can easily be applied to different telecommunications networks. For example, when a UMTS network is co-sited with a LTE network, in which the LTE network and the UMTS network share the same antenna and the same frequency spectrum, the antenna gain of the base station and the path loss from the base station to the UT are the same for both UMTS and LTE (i.e., G_{BS}^{UMTS}=G_{BS}^{LTE} and Lₚₐₜₕ^{UMTS}=Lₚₐₜₕ^{LTE}). Consequently, we can determine the E-UTRA RSRP values value for a UT in the LTE network at the known location (x, y) as described in equation (1.11) below.

$$RSRP ( x , y ) = RSCP ( x , y ) + ( {EIRP}_{BS}^{LTE} - {EIRP}_{BS}^{UMTS} ) + ( {G}_{MS}^{LTE} - {G}_{MS}^{UMTS} ) - ( {L}_{MS}^{LTE} - {L}_{MS}^{UMTS} ) . \qquad Equation ( 1.11 )$$

At Step 406, entries are created in the database within the CLS 110 in which the predicted values of Rx_Lev for the serving sector and the neighboring sectors, along with their corresponding UT locations are stored. Additionally, if any associated sector identities are available, this information is also stored in correspondence with their UT locations. The above-described process is then repeated in order to build up the database within the CLS 110 over time and location. Additionally, it should be noted that there exist alternative methods for using the obtained radio measurements and determined locations of user terminals by the co-sited telecommunications network in order to build up the database within the CLS 110. As an example, for all determined locations of user terminals in the co-sited communications network that fall into a region, their predicted location vectors may be averaged as one common vector, and the predicted location is represented by the pixel location (xᵢ, yᵢ) representing the region.

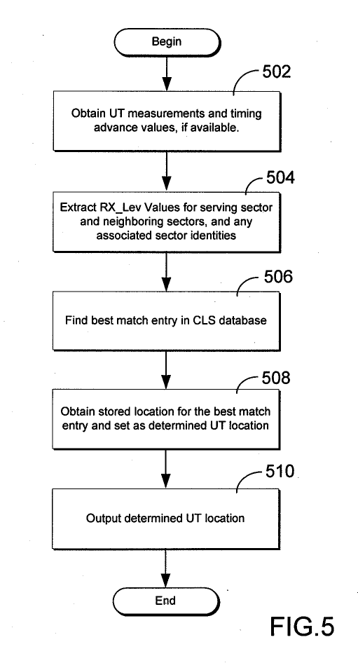

FIG. 5 illustrates a flowchart for determining a location of a user terminal in accordance with an embodiment of the present invention. After initialization, at Step 502, the CLS 110 obtains UT internal measurements and timing advance values from a BTS, if available.

At Step 504, Rx_Lev values for the serving sector and any neighboring sectors, and any associated cell identities are extracted from the obtained UT internal measurements. Assuming a set of power measurements l₁, l₂ . . . lₙ (e.g., Rx_Lev values) from the UT are available for all n measured cells, a corresponding measurement vector, M, for the UT may be represented as shown in equation (1.12) below.

M=[(mₗ₁),(mₗ₂),(mₗ₃), . . . ,(mₗₙ)], Equation (1.12):

where mₗ₁, mₗ₂, . . . mₗₙ, are power measurements (e.g., Rx_Lev values) at the current UT location.

As Step 506, the best match entry in the CLS database 110 can be determined by computing a matching score from the deviation of the entries E(xᵢ,yᵢ) in the look-up table and M by a predetermined method. For example, the matching score may be computed, but is not limited to, using a method of least-mean squares (“LMS”). As one example, the matching score is computed using the least absolute value, which is a special case of LMS, and is given by equation (1.13) below.

$${S}_{i} = {\sum }_{k = 1}^{n} \vert {l}_{k , i} - {m}_{lk} \vert . \qquad Equation ( 1.13 )$$

At Step 508, the pixel location (xᵢ, yᵢ) in the look-up table corresponding to the minimum value of Sᵢ is considered the best match entry, and pixel location (xᵢ, yᵢ) is determined to be the location of the UT having the measurement vector M.

At Step 510, the CLS 110 outputs the pixel location (xᵢ, yᵢ) as the determined location of the UT.

Additionally, it should be noted that the determined location of the UT is not limited to a single pixel location (xᵢ, yᵢ) as the best match entry in the database, and other methods to determine the location of the UT based on the information stored in the database should be apparent to one of ordinary skill in the art. For example, the CLS 110 may extract two or more of the closest matching entries to the measurement vector M based on the calculated values of Sᵢ, and perform a method of interpolation to determine the location of the UT based on the relative values of Sᵢ for each of the closest matching entries and the corresponding pixel locations.

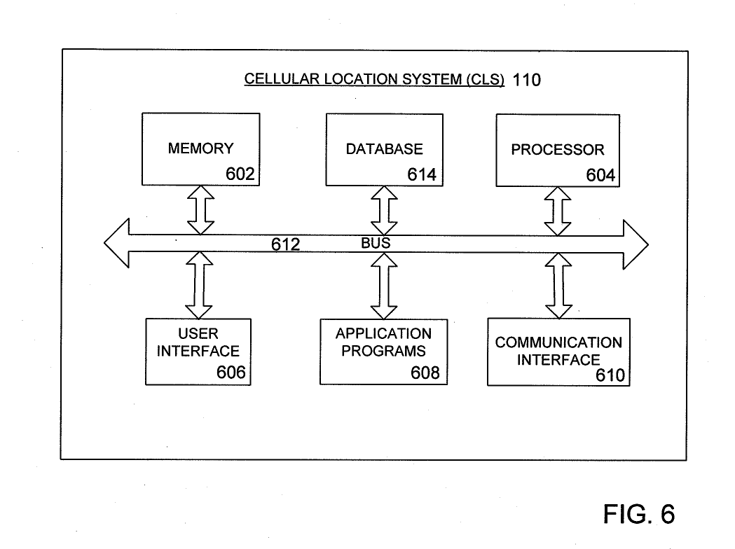

FIG. 6 is a representative Cellular Location System 110 as shown in the communications system of FIG. 1. In FIG. 6, the CLS 110 includes a memory 602, a processor 604, user interface 606, application programs 608, communication interface 610, a bus 612, and a database 614.

The processor 604 can be a grouping of one or more processors for performing the necessary functions of the CLS 110. For example, UT measurements obtained by the CLS 110 via the RNC 106, can be processed by a data processor to form the location sensitive entries in the database 614. Similarly, UT measurements obtained by the CLS 110 via the RNC 106, for comparison to the entries within the database 614 can be processed by a match processor for comparing and determining the best match as the determined UT location.

The memory 602 can be computer-readable media used to store executable instructions, computer programs, algorithms or the like thereon. The memory 602 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer programs” is intended to encompass an executable program that exists permanently or temporarily on any computer-readable medium. The instructions, computer programs and algorithms stored in the memory 602 cause the CLS 110 determine the location of UT as described above. The instructions, computer programs and algorithms stored in the memory 602 are executable by one or more processors 604, which may be facilitated by one or more of the application programs 608.

The application programs 608 may also include, but are not limited to, an operating system or any special computer program that manages the relationship between application software and any suitable variety of hardware that helps to make-up a computer system or computing environment of the CLS 110. General communication between the components in the CLS 110 is provided via the bus 612.

The user interface 606 allows for interaction between a user and the CLS 110. The user interface 606 may include a keypad, a keyboard, microphone, and/or speakers. The communication interface 610 provides for two-way data communications from the CLS 602. By way of example, the communication interface 610 may be a digital subscriber line (DSL) card or modem, an integrated services digital network (ISDN) card, a cable modem, or a telephone modem to provide a data communication connection to a corresponding type of telephone line. As another example, communication interface 610 may be a local area network (LAN) card (e.g., for Ethernet™ or an Asynchronous Transfer Model (ATM) network) to provide a data communication connection to a compatible LAN.

Further, the communication interface 610 may also include peripheral interface devices, such as a Universal Serial Bus (USB) interface, a Personal Computer Memory Card International Association (PCMCIA) interface, and the like. The communication interface 610 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown).

While the above embodiments of the invention have been disclosed, numerous modifications and changes will occur to those skilled in the art to which this invention pertains. The claims annexed to and forming a part of this specification are intended to cover all such embodiments and changes as fall within the true spirit and scope of the present invention.

1. A cellular location method for determining a location of a specified user terminal in a communications network, said cellular location method being used in a cellular location system including a database, said cellular location method comprising:
obtaining radio measurements from a user terminal located in the communications network;
extracting information from the obtained radio measurements such that the location of the user terminal can be determined;
determining the location of the user terminal based on the extracted information; and
storing the determined location of the user terminal and the extracted information as an entry in the database;
estimating information for the user terminal for another location in the communications network; and
storing the other location of the user terminal and the estimated information as an entry in the database,
wherein the determined location of the user terminal and the other location of the user terminal are stored in the database such that the determined location of the user terminal and the other location of the user terminal are retrievable based upon a matching score between the extracted information from the user terminal and extracted information from the specified user terminal, and the estimated information for the user terminal and the extracted information from the specified user terminal, respectfully.

2. The cellular location method of claim 1, wherein said obtaining radio measurements from the user terminal is performed when the user terminal is in handover.

3. The cellular location method of claim 1, wherein when the determined location of the user terminal is retrievable based upon the matching score between the extracted information from the user terminal and the extracted information from the specified user terminal, the location of the specified user terminal is determined based on the determined location of the user terminal.

4. The cellular location method of claim 1, wherein when the estimated location of the user terminal is retrievable based upon the matching score between the estimated information for the user terminal and the extracted information from the specified user terminal, the location of the specified user terminal is determined based on the other location of the user terminal.

5. The cellular location method of claim 1,
wherein the extracted information from the user terminal is stored as an extracted location vector including one or more power values for each of n available cells within the communications network,
wherein the estimated information for the user terminal is stored as an estimated location vector including one or more power values for each of n available cells within the communications network,
wherein the extracted information from the specified terminal is represented as a measurement vector including one or more power values for each of n available cells within the communications network, and
wherein the matching score is computed by calculating a least-mean squares (LMS) difference between the extracted location vector and the measurement vector, and the estimated location vector and the measurement vector.

6. The cellular location method of claim 1,
wherein the estimated information for the user terminal is estimated based on the extracted information from the user terminal.

7. The cellular location method of claim 1, further comprising:
obtaining co-sited communications network information, the co-sited communications network information including a determined location for a user terminal located in a co-sited communications network and user terminal information for the user terminal located in a co-sited communications network,
wherein the estimated information for the user terminal is estimated based on the obtained co-sited communications network information.

8. A cellular location system for determining a location of a specified user terminal in a communications network, said cellular location system comprising:
an obtaining unit for obtaining radio measurements from a user terminal located in the communications network;
an extracting unit for extracting information from the obtained radio measurements such that the location of the user terminal can be determined;
a determination unit for determining the location of the user terminal based on the extracted information;
an estimation unit for estimating information for the user terminal for another location in the communications network; and
a database for storing the determined location of the user terminal and the extracted information as an entry, and storing the other location of the user terminal and the estimated information as an entry,
wherein the determined location of the user terminal and the other location of the user terminal are stored in the database such that the determined location of the user terminal and the other location of the user terminal are retrievable based upon a matching score between the extracted information from the user terminal and extracted information from the specified user terminal, and the estimated information for the user terminal and the extracted information from the specified user terminal, respectfully.

9. The cellular location system of claim 8, wherein said obtaining unit obtains radio measurements from the user terminal is when the user terminal is in handover.

10. The cellular location system of claim 8, wherein when the determined location of the user terminal is retrieved based upon the matching score between the extracted information from the user terminal and the extracted information from the specified user terminal, the location of the specified user terminal is determined based on the determined location of the user terminal.

11. The cellular location system of claim 8, wherein when the estimated location of the user terminal is retrievable based upon the matching score between the estimated information for the user terminal and the extracted information from the specified user terminal, the location of the specified user terminal is determined based on the other location of the user terminal.

12. The cellular location system of claim 8,
wherein the extracted information from the user terminal is stored in said database as an extracted location vector including one or more power values for each of n available cells within the communications network,
wherein the estimated information for the user terminal is stored in said database as an estimated location vector including one or more power values for each of n available cells within the communications network,
wherein the extracted information from the specified terminal is represented as a measurement vector including one or more power values for each of n available cells within the communications network, and
wherein the matching score is computed by calculating a least-mean squares (LMS) difference between the extracted location vector and the measurement vector, and the estimated location vector and the measurement vector.

13. The cellular location system of claim 8,
wherein said estimation unit estimates the estimated information for the user terminal based on the extracted information from the user terminal.

14. The cellular location system of claim 8,
wherein said obtainment unit obtains co-sited communications network information, the co-sited communications network information including a determined location for a user terminal located in a co-sited communications network and user terminal information for the user terminal located in a co-sited communications network information,
wherein said estimation unit estimates the estimated information for the user terminal based on the obtained co-sited communications network information.

15. A non-transitory computer readable recording medium having stored thereon a cellular location program that when executed causes a computer to perform a cellular location method for determining a location of a specified user terminal in a communications network, wherein the cellular location method is used in a cellular location system including a database, the cellular location method comprising:
obtaining radio measurements from a user terminal located in the communications network;
extracting information from the obtained radio measurements such that the location of the user terminal can be determined;
determining the location of the user terminal based on the extracted information; and
storing the determined location of the user terminal and the extracted information as an entry in the database;
estimating information for the user terminal for another location in the communications network; and
storing the other location of the user terminal and the estimated information as an entry in the database,
wherein the determined location of the user terminal and the other location of the user terminal are stored in the database such that the determined location of the user terminal and the other location of the user terminal are retrievable based upon a matching score between the extracted information from the user terminal and extracted information from the specified user terminal, and the estimated information for the user terminal and the extracted information from the specified user terminal, respectfully.

16. The non-transitory computer readable recording medium of claim 15, wherein said obtaining radio measurements from the user terminal is performed when the user terminal is in handover.

17. The non-transitory computer readable recording medium of claim 15,
wherein when the determined location of the user terminal is retrievable based upon the matching score between the extracted information from the user terminal and the extracted information from the specified user terminal, the location of the specified user terminal is determined based on the determined location of the user terminal, or
wherein when the estimated location of the user terminal is retrievable based upon the matching score between the estimated information for the user terminal and the extracted information from the specified user terminal, the location of the specified user terminal is determined based on the other location of the user terminal.

18. The non-transitory computer readable recording medium of claim 15,
wherein the extracted information from the user terminal is stored as an extracted location vector including one or more power values for each of n available cells within the communications network,
wherein the estimated information for the user terminal is stored as an estimated location vector including one or more power values for each of n available cells within the communications network,
wherein the extracted information from the specified terminal is represented as a measurement vector including one or more power values for each of n available cells within the communications network, and
wherein the matching score is computed by calculating a least-mean squares (LMS) difference between the extracted location vector and the measurement vector, and the estimated location vector and the measurement vector.

19. The non-transitory computer readable recording medium of claim 15,
wherein the estimated information for the user terminal is estimated based on the extracted information from the user terminal.

20. The non-transitory computer readable recording medium of claim 15, further comprising:
obtaining co-sited communications network information, the co-sited communications network information including a determined location for a user terminal located in a co-sited communications network and user terminal information for the user terminal located in a co-sited communications network information,
wherein the estimated information for the user terminal is estimated based on the obtained co-sited communications network information.
